(19) United States
(12) Patent Application Publication
(10) Pub. No.: US 2008/0217132 A1
(43) Pub. Date: Sep. 11, 2008

(54) Viscous Fluid Coupling Device

(75) Inventors: Tadayoshi Sato, Chita-gun (JP); Kazunari Adachi, Chiryu-shi (JP); Mitsutoshi Hagiwara, Anjo-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/036,803

(22) Filed: Feb. 25, 2008

(30) Foreign Application Priority Data
Mar. 7, 2007 (JP) 2007-056638
Dec. 20, 2007 (JP) 2007-328770

(51) Int. Cl. F16D 31/00

(52) U.S. Cl. 192/58.63

(57) ABSTRACT

A viscous fluid coupling device includes a drive shaft, a housing rotatably supported by the drive shaft, a partition wall dividing an interior space of the housing into an operation chamber and a storage chamber having a circular arc portion, a rotor accommodated in the operation chamber and fixed to the drive shaft, a supply passage for supplying operating fluid from the storage chamber to the operation chamber, a return passage for returning the operating fluid in the operation chamber to the storage chamber, and a first valve disposed in the supply passage and the return passage respectively. The first valve is closed when the drive shaft rotates at a speed lower than a predetermined rotation speed and opened when the drive shaft rotates at the predetermined rotation speed. The viscous coupling device further includes an opening of the supply passage and a second valve for opening and closing the opening.

### CROSS REFERENCE TO RELATED APPLICATIONS

This application is based on and claims priority under 35 U.S.C. §119 to Japanese Patent Application 2007-056638, filed on Mar. 7, 2007 and Japanese Patent Application 2007-328770, filed on Dec. 20, 2007, the entire contents of which are incorporated herein by reference.

### FIELD OF THE INVENTION

The present invention relates to a viscous fluid coupling device, which is applied to a cooling fan control device of an internal combustion engine.

### BACKGROUND

A known viscous fluid coupling device described, for example, in JP8023377B is conventionally widely applied to a cooling fan of an engine for a vehicle. The conventional viscous fluid coupling device controls a rotation speed of the cooling fan based on an air temperature after the air passes through a radiator. The viscous fluid coupling device described above includes a hollow drive shaft, a housing rotatably supported by the drive shaft, a partition wall dividing an interior space of the housing into a storage chamber and an operation chamber and having an hole in the center for releasing air therefrom, a rotor accommodated in the operation chamber and fixed to the drive shaft, and a valve plate for opening and closing a circulating hole of the partition wall. The valve plate variably controls circulation of operating fluid returned to the storage chamber via a return passage after the operating fluid flows through a labyrinth groove, on the basis of the air temperature.

An annular shaped partition is disposed vertically within the storage chamber described above. The partition wall divides an internal space of the storage chamber into a circular shaped front chamber and a circular shaped rear chamber. In addition, one end of the return passage is open into the operation chamber and the other end of the return passage is open into the front chamber. Furthermore, a small circular shaped communicating hole is formed at an outer peripheral end of the partition wall located approximately 180 degrees opposite to the other peripheral end of the partition wall to which the return passage is close. The front chamber communicates with the rear chamber via the communicating hole.

In the conventional viscous fluid coupling device, after the engine is warmed up, the valve plate is rotated by a bimetallic member activated on the basis of a temperature so as to open the circulating hole. Then, operating fluid in the rear chamber and the front chamber of the storage chamber flows into the operation chamber through the circulating hole. Thereafter, rotating torque transmitted from the rotor is transferred to the housing by viscosity of the operating fluid within the labyrinth groove, and then the operating fluid is returned to the front chamber via the return passage. In this case, smooth circulation of the operating fluid is achieved because the operating fluid in the front chamber is drawn in an outer circumferential direction by centrifugal force.

Meantime, when the engine is stopped under the condition where the circulating hole is closed by the valve plate and when rotation of the housing is stopped under the condition where the return passage is positioned at the lower side, the operating fluid ill the front chamber flows back into the operation chamber from the front chamber through the return passage. However, only a small volume of the operating fluid of the rear chamber flows into the operation chamber from the hole of the partition wall and the rest of a large volume of the operating fluid is stored in the rear chamber up to a lower edge of the hole of a high fluid level. Accordingly, only a small volume of the operating fluid, which is the same low fluid level as the operating fluid of the front chamber, is stored in the operating chamber. Consequently, the rotating torque transmitted from the rotor to the housing significantly decreases right after the engine in a cool-down state is started, thereby preventing the housing from rotating at a high speed in accordance with rotation of the rotor and reducing the rotation speed of the cooling fan.

The conventional viscous fluid coupling device is effective for noise reduction when the circulating hole is closed. However, when the engine is stopped under the condition where an engine room is at a high temperature and the circulating hole is opened, the operating fluid flows into the operation chamber through the circulating hole. Under this condition, when the engine is started, the rotating torque transmitted from the rotor to the housing increases due to the operating fluid supplied to the operation chamber. Accordingly, the rotation of the housing in accordance with the rotation of the rotor occurs, thereby increasing noise caused by rotation of the cooling fan and causing poor fuel efficiency because the cooling fan is unnecessarily rotated.

A need thus exists for a viscous fluid coupling device, which is not susceptible to the drawback mentioned above.

### SUMMARY OF THE INVENTION

According to an aspect of the present invention, a viscous fluid coupling device includes a drive shaft, a housing rotatably supported by the drive shaft, a partition wall dividing an interior space of the housing into an operation chamber and a storage chamber having a circular arc portion, a rotor accommodated in the operation chamber and fixed to the drive shaft, a supply passage for supplying operating fluid from the storage chamber to the operation chamber, a return passage for returning the operating fluid in the operation chamber to the storage chamber, and a first valve disposed in the supply passage and the return passage respectively. The first valve is closed for interrupting communication between the storage chamber and the operation chamber when the drive shaft rotates at a speed lower than a predetermined rotation speed and opened for allowing the communication between the storage chamber and the operation chamber when the drive shaft rotates at the predetermined rotation speed. In the viscous fluid coupling device. The supply passage has an opening formed in the circular arc portion of the storage chamber. The viscous fluid coupling device further includes a second valve for opening and closing the opening of the supply passage.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross-section view illustrating a viscous fluid coupling device according to an embodiment of the present invention; and

FIG. 2 is a cross-section view taken along the line II-II of FIG. 1.

### DETAILED DESCRIPTION

An embodiment of the present invention will be explained with reference to the illustrations of the drawing figures as follows.

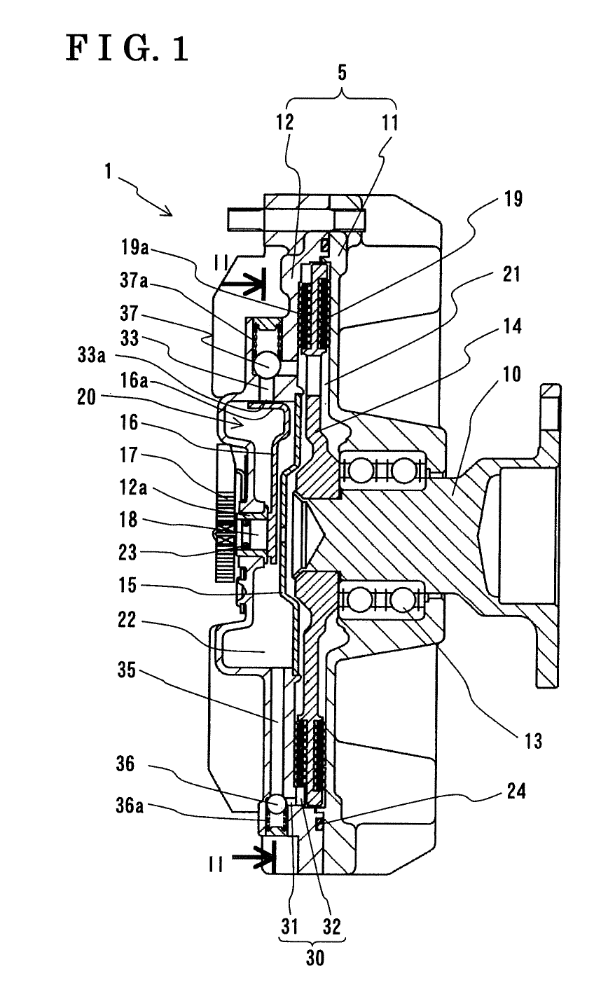

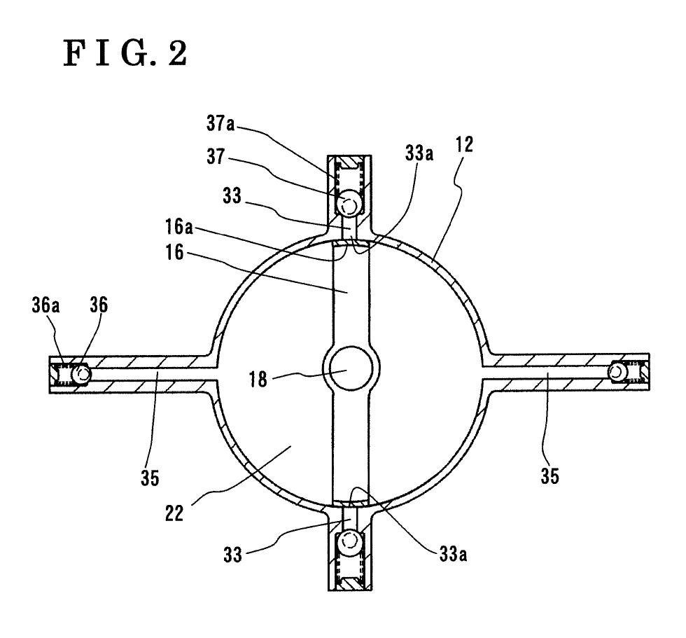

As illustrated in FIGS. 1 and 2, a viscous fluid coupling device 1 mainly includes a drive shaft 10, a case 11, a cover 12, a bearing 13, a rotor 14, a partition wall 15, a plate-shaped valve (a second valve) 16, a bimetallic member 17, and a rod 18. A housing 5 is composed of the case 11 and the cover 12.

The drive shaft 10 to which the circular plate-shaped rotor 14 is fixed integrally rotates with the rotor 14. The housing 5 accommodates the rotor 14 and is rotatably supported by the drive shaft 10 via the bearing 13. In addition, a labyrinth groove 19 is formed in a torque transfer surface where the rotor 14 and the case 11 face each other. A labyrinth groove 19a is also formed in a torque transfer surface where the rotor 14 and the cover 12 face each other. The cover 12 is integrally fixed to an outer periphery of the case 11 with screws (not shown) via a seal member 24. The case 11 and the cover 12 compose the housing 5 within which an internal space 20 is formed.

An outer peripheral edge of the partition wall 15 is fixed to the cover 12. The partition wall 15 divides the internal space 20 into an operation chamber 21 in which the rotor 14 is accommodated and a storage chamber 22 located at the side of the cover 12 and having a circular arc portion (a circumferential portion formed with a pair of the circular arc portions connected to each other is applied in the embodiment). Viscous fluid such as silicone oil (operating fluid) is filled in the storage chamber 22 and the operation chamber 21.

Two supply passages 33 are disposed in the cover 12 so as to be located radially outwardly relative to the central point of an internal space of the cover 12. In addition, the supply passages 33 are arranged so as to face each other on a straight line crossing the central axis of the rod 18. Each of the supply passages 33 has an opening 33a in the circular arc portion of the storage chamber 22. The storage chamber 22 communicates with the operation chamber 21 via the supply passages 33. In addition, a pumping mechanism 30 consisting of a pump bore 31 and a pump projection 32 is formed on the outer peripheral edge of the cover 12 for supplying the viscous fluid of the operation chamber 21 to the storage chamber 22. The pump bore 31 communicates with the storage chamber 22 via two return passages 35 formed perpendicularly to two of the supply passages 33.

The rod 18 is rotatably supported in the central part of the cover 12. The spiral-shaped bimetallic member 17 is fixed to one end of the rod 18. The plate-shaped valve 16 integrally rotating with the rod 18 is fixed to the other end of the rod 18. Moreover, a seal member 23 is provided on the rod 18. The seal member 23 prevents the viscous fluid from leaking between the rod 18 and a bushing 12a press-fitted to the cover 12.

The valve 16 forms a plate shape. Axially bended portions 16a are provided at both ends of the valve 16. The valve 16 is formed so that the openings 33a of the supply passages 33 being open into two of the circular arc portions of the storage chamber 22 are opened and closed by outer peripheral side faces of the bended portions 16a respectively.

The bimetallic member 17 is actuated on the basis of an air temperature from behind a radiator. Then, the valve 16 is rotated via the rod 18 in reaction to the actuation of the bimetallic member 17, thereby controlling opening and closing of the openings 33a of the supply passages 33.

Ball valves (a first valve) 36 and 37 each serving as an on-off valve are provided in the return passage 35 and the supply passage 33 respectively. The ball valves 36 and 37 each serving as the on-off valve are closed for interrupting communication between the storage chamber 22 and the operation chamber 21 when the drive shaft 10 rotates at a speed lower than a predetermined rotation speed and opened for allowing the communication between the storage chamber 22 and the operation chamber 21 when the drive shaft 10 rotates at the predetermined rotation speed. The ball valves 36 and 37 are radially inwardly biased by springs 36a and 37a respectively. The ball valves 36 and 37 close the return passage 35 and the supply passage 33 respectively in stationary conditions where the rotor 14 and the housing 5 are not rotated because an engine is not activated. The ball valves 36 and 37 are configured so as to be opened by the action of centrifugal force when the centrifugal force occurring at a rotation speed of a fan (not shown) larger than the predetermined rotation speed exceeds biasing force of 36a and 37a respectively.

Next, operations of the viscous fluid coupling device 1 will be explained as follows.

The rotor 14 integrally rotates with the drive shaft 10 connected to a drive means (not shown) and rotatably driven by the drive means. Hereby, the viscous fluid in the operation chamber 21 sequentially flows into the storage chamber 22 by the action of the pump mechanism 30. Meanwhile, the bimetallic member 17 is actuated on the basis of the temperature, thereby rotating the valve 16 via the rod 18 so as to open and close the openings 33a of the supply passages 33. Hereby, the flow level of the viscous fluid between the storage chamber 22 and the operation chamber 21 is adjusted and torque transmitted from the drive shaft 10 to the housing 5 is controlled. When the bimetallic member 17 is at a high ambient temperature, the openings 33a are fully opened. Accordingly, the whole volume of the viscous fluid in the storage chamber 22 is supplied to the operation chamber 21.

FIGS. 1 and 2 illustrate the conditions of the viscous fluid coupling device 1 during cooling time when the engine is stopped. The supply passages 33 within the cover 12 are closed by the valve 16. Each of the supply passages 33 and the return passages 35 are closed by the ball valves 36 and 37 respectively. When the engine is started from this condition, the housing 5 to which the fan is mounted starts to rotate at a low speed in reaction to resistance of the bearing 13 or the like even under the condition where the volume of the viscous fluid in the operation chamber 21 is small. When the rotation speed of the fan reaches the predetermined rotation speed (for example, 200 revolutions per minute), the ball valves 36 and 37 are opened by the centrifugal force.

However, the supply passages 33 remain to be closed by the valve 16 because the bimetallic member 17 is not actuated when an ambient temperature is low. Under this condition, the viscous fluid is not supplied to the operation chamber 21 and the viscous fluid in the operation chamber 21 is returned to the storage chamber 22 by means of the pump mechanism 30. In this case, the volume of the viscous fluid in the labyrinth grooves 19 and 19a becomes small, so that torque transmitted from the rotor 14 to the housing 5 is not transferred to the fan. Accordingly, the rotation speed of the fan does not increase. Consequently, noise occurring when the engine is started during cooling time does not increase. Moreover, poor fuel efficiency is prevented because the fan is not driven.

When the ambient temperature starts rising, the valve 16 is rotated by the bimetallic member 17 that is actuated on the basis of the temperature, and then the openings 33a of the supply passages 33 start to open. Under this condition, while the viscous fluid coupling device 1 is rotating, the viscous fluid in the storage chamber 22 flows into the labyrinth grooves 19 and 19a via each of the supply passage 33 by the centrifugal force. Accordingly, the torque transmitted from the rotor 14 is transferred to the housing 5 by viscosity of the viscous fluid within the labyrinth grooves 19 and 19a, thereby increasing the rotation speed of the fan. The viscous fluid supplied into the labyrinth grooves 19 and 19a is returned to the storage chamber 22 via the return passage 35 by means of the pump mechanism 30. In this way, the viscous fluid circulates between the stored chamber 22 and the operation chamber 21.

When the engine is stopped at a high ambient temperature, rotation of the drive shaft 10 stops. Accordingly, the centrifugal force acting on the ball valves 36 and 37 is inactivated. Thereafter, the supply passage 33 and the return passage 35 are closed by the biasing force of the springs 36 and 37 respectively, thereby preventing the viscous fluid from flowing from the storage chamber 22 to the operation chamber 21 even when the supply passage 33 and the return passage 35 are located in any position. Under this condition, when the ambient temperature drops and then the bimetallic member 17 turns to a low temperature state, the openings 33a of the supply passages 33 are closed by the valve 16. Afterward, a condition of the valve 16 returns to the conditions illustrated in FIGS. 1 and 2.

Although a ball valve being opened and closed by centrifugal force is explained as an on-off valve for opening and closing the supply passage 33 and the return passage 35 in the present embodiment, the on-off valve may not be limited to the ball valve. An electromagnetic valve being opened and closed by a solenoid or a hydraulic valve being opened and closed by oil pressures may be applied.

Moreover, although the valve 16 rotated by the bimetallic member 17 that is activated on the basis of the ambient temperature for opening and closing the openings 33a of the supply passages 33, is explained in the embodiment, the openings 33a of the supply passages 33 may be opened and closed by a solenoid for detecting an ambient temperature or an engine coolant temperature so as to be axially activated.

As explained above, according to the embodiment of the present invention, when the engine is stopped under the condition where the engine room is at a high temperature, the viscous fluid is prevented from flowing into the operation chamber 21 by closing the supply passages 33 and the return passages 35, thereby preventing rotation of the housing 5 in accordance with rotation of the rotor 14 within the viscous fluid coupling device 1. Accordingly, the torque transmitted from the housing 5 is not transferred to the fan, so that the fan is not rotated. Consequently, noise is reduced and poor fuel efficiency is prevented. In addition, the total volume of the viscous fluid in the storage chamber 22 is supplied to the operation chamber 21 by centrifugal force generated by rotation of the viscous fluid coupling device 1, so that the viscous fluid is effectively used.

According to another aspect of the embodiment of the present invention, in the viscous coupling device 1, the valve 16 forms the plate shape and includes the axially bended portions 16a, and the openings 33a of the supply passages 33 are opened and closed by the outer peripheral side faces of the bended portions 16a respectively.

Accordingly, the viscous fluid is supplied from the storage chamber 22 to the operation chamber 21 by a simple valve configuration.

According to a further aspect of the embodiment of the present invention, the ball valves 36 and 37 each serving as the on-off valve are opened and closed by the centrifugal force of the viscous coupling device 1.

Accordingly, the fan is operated so as to rotate on the basis of a rotation speed of the drive shaft 10.

According to another aspect of the embodiment of the present invention, the valve 16 is rotated on the basis of the temperature so as to open and close the openings 33a of the supply passages 33 in the viscous coupling device 1.

According to a further aspect of the embodiment of the present invention, the storage chamber 21 includes a pair of the circular arc portions facing each other in the viscous coupling device 1.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A viscous fluid coupling device comprising:
a drive shaft;
a housing rotatably supported by the drive shaft;
a partition wall dividing an interior space of the housing into an operation chamber and a storage chamber having a circular arc portion;
a rotor accommodated in the operation chamber and fixed to the drive shaft;
a supply passage for supplying operating fluid from the storage chamber to the operation chamber, the supply passage including an opening formed in the circular arc portion of the storage chamber;
a return passage for returning the operating fluid in the operation chamber to the storage chamber;
a first valve disposed in the supply passage and the return passage respectively, the first valve being closed for interrupting communication between the storage chamber and the operation chamber when the drive shaft rotates at a speed lower than a predetermined rotation speed and being opened for allowing the communication between the storage chamber and the operation chamber when the drive shaft rotates at the predetermined rotation speed; and
a second valve for opening and closing the opening of the supply passage.

2. The viscous fluid coupling device according to claim 1, wherein the second valve forms a plate shape and includes an axially bended portion, and the opening of the supply passage is opened and closed by an outer peripheral side face of the bended portion.

3. The viscous fluid coupling device according to claim 1, wherein the first valve is opened and closed by centrifugal force.

4. The viscous fluid coupling device according to claim 1, wherein the second valve is rotated on the basis of a temperature to open and close the opening of the supply passage.

5. The viscous fluid coupling device according to claim 1, wherein the storage chamber includes a pair of the circular arc portions facing each other.
